(19) United States
(12) Patent Application Publication
(10) Pub. No.: US 2008/0091828 A1
(43) Pub. Date: Apr. 17, 2008

(54) METHOD AND SYSTEM FOR FINE AND COURSE-GRAINED AUTHORIZATION OF PERSONAL FEED CONTENTS

(75) Inventor: William Charles Mortimore, San Francisco, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Rearden Commerce, Inc., San Mateo, CA (US)

(21) Appl. No.: 11/549,950

(22) Filed: Oct. 16, 2006

(51) Int. Cl. G06F 15/16

(52) U.S. Cl. 709/227

(57) ABSTRACT

In one embodiment, method that can be performed on a system, is provided for fine and course grained authorization of personal feed contents. In one embodiment, the method comprises generating one or more profiles, each profile to receive one or more feeds over a network, the feeds for each profile selected based on one or more of pre-identification of a selected feed and pre-identified content; and for each profile, providing one or more selected users with access to the feeds of the respective profiles.

### BACKGROUND OF THE INVENTION

As feeds of various natures become more and more important to daily use of data, improved readers become available that present the feeds as pseudo-static updated content. It is desirable to be able to use these feeds and also to be able share certain parts of the feeds with other people, such as co-workers.

What is clearly needed is a system and method that allows either fine- or coarse-grained authorization of personal feed contents to be shared with others.

### SUMMARY

In one embodiment, method that can be performed on a system, is provided for fine and course grained authorization of personal feed contents. In one embodiment, the method comprises generating one or more profiles, each profile to receive one or more feeds over a network, the feeds for each profile selected based on one or more of pre-identification of a selected feed and pre-identified content; and for each profile, providing one or more selected users with access to the feeds of the respective profiles.

### BRIEF DESCRIPTION OF FIGURES

FIG. 1 illustrates an exemplary system with, among other elements, feed reader and Internet, in accordance with one embodiment;

FIG. 2 presents shows an exemplary process of reader, in accordance with one embodiment; and

FIG. 3 presents an exemplary process whereby the primary user may configure a profile for a secondary user.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

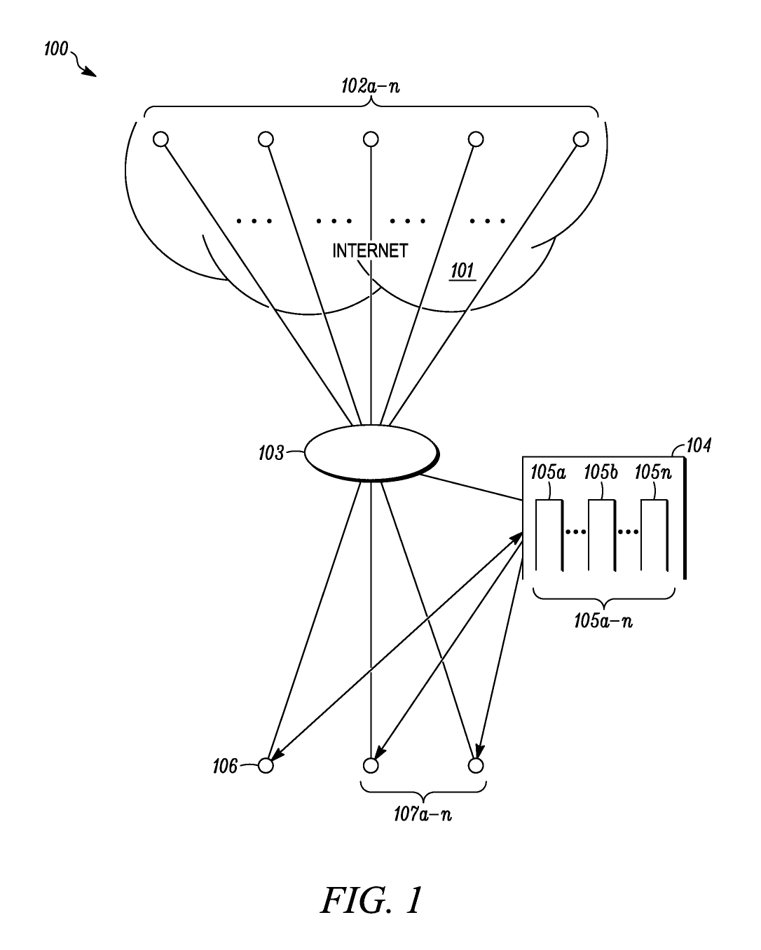

FIG. 1 shows an exemplary system 100 with, among other elements, feed reader 103 and Internet 101. Internet 101 contains a number of feed sources 102 a-n, which sources could publish feeds in formats such as RSS, Atom, etc. A feed, as referenced herein, includes the electronic distribution of text, audio or video. A feed may refer to a syndicated radio or TV program that is transmitted on a regular basis, or to a text and graphics feed that is available on a Web site or blog.

Various different users could be reading the output of reader 103, such as, for example, primary user 106, and also secondary users 107 a-n who could be, for example, family members, secretary, colleagues, or any other such users associated with primary user 106. Attached to reader 103 is a permission control system 104, which contains a multitude of profiles 105 a-n. These profiles may be used to determine the output that is available to secondary users 107 a-n.

For example, the permission control system may be implemented such that secondary users must log in specifically to see the primary user's items as he makes them available; or in other cases the control system may be integrated into the secondary user's reader content through a shared system. In such a case, for example, multiple instances of permission control system 104 could be cross-integrated with one another, and multiple instances of reader 103 may also be cross integrated.

Profiles may contain information about various feeds and also about various types of content from any one feed. Thus the permissions and exclusions may be set on a per-feed (coarse-grained) basis and also on a content-type (fine-grained) basis.

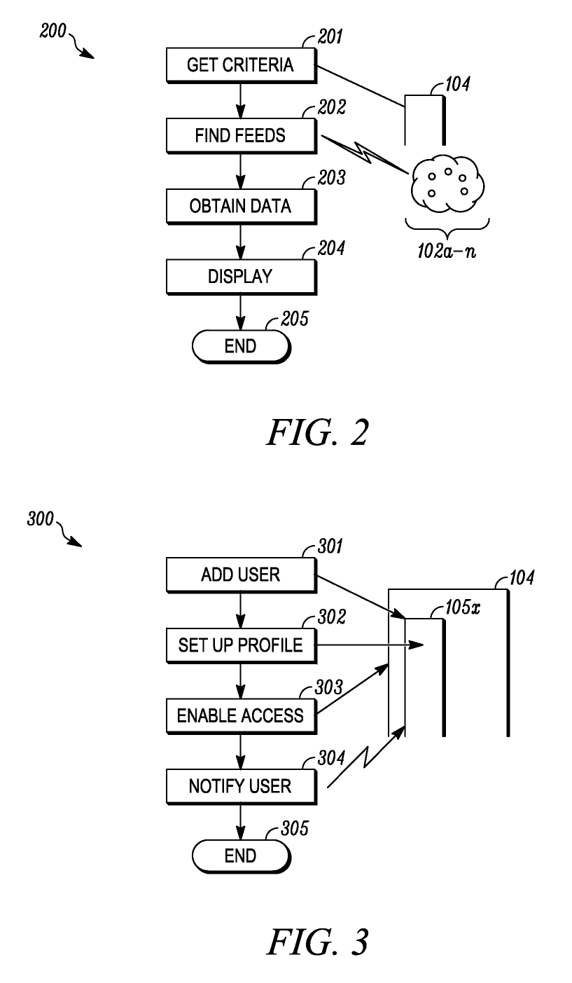

FIG. 2 shows an exemplary process 200 of reader 103. In step 2011 the feed and content permission tables 104 are loaded. In step 202, the feeds 102 a-n are sought on the Internet and contracted for new content. In step 203, the data is obtained and in step 204 the data is displayed. Then in step 205 the process ends. It is clear that this exemplary method is a simplification. Typically, the process depicted in FIG. 2 could loop from step 205 back to step 201 automatically on a frequent basis, such as every 1 minute, every 5 minutes, every 30 minutes, and so forth. In other cases, a user could set different run frequencies for each of various different feeds and various types of content.

FIG. 3 shows an exemplary process 300 whereby the primary user 106 may configure a profile for a secondary user such as, for example, his secretary. In step 301, the primary user 106 adds a profile, thus creating a new profile 105× within his permission control system 104. In step 302 user 106 configures the new profile 105x by, for example, adding specific feeds and content types from his own profile, or, in other cases, by copying a prior profile 105y and editing (adding and removing) the various feeds and content types to create profile 105x. In step 303, user 106 enables access to profile 105x for one or more secondary users. In step 304, the secondary user is notified that he now has access to feeds and content available through his profile 105x, and in step 305, the process ends.

In one embodiment, The primary user (i.e. agent, supervisor, boss, HR etc.) would typically enter a secondary users (customer, employee etc.) id, and then set up a profile. In most cases, the secondary user would already be a user in an existing account of another system (i.e. e-service portal), so “checking” a box on that users (customers, employee etc.) account in the other system profile would enable to transfer all relevant information into this new profile. In other cases, a process or filter is used to determine for which customers to create profiles automatically. In yet other cases, an invite is issued to a customer to set up his own profile.

One additional exemplary case of the present invention is by associating role to content-type or permission type. For instance, a user could configure the role of manger to be able to see anything purchased under their work profile. The role of delegate could be configured to see all travel related data. The role of all might be allowed to see any public data.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

1. A method comprising:
Generating one or more profiles, each profile to receive one or more feeds over a network, the feeds for each profile selected based on one or more of pre-identification of a selected feed and pre-identified content;
For each profile, providing one or more selected users with access to the feeds of the respective profiles.

2. The method of claim 1, wherein the generating is performed, at least in part, by a primary user, and the selected users are secondary users.

3. The method of claim 1, wherein the generating the one or more profiles includes generating a new profile.

4. The method of claim 1, wherein the generating the one or more profiles includes copying a prior profile.

5. The method of claim 4, wherein copying another profile further includes one of adding or removing selected feeds of the prior profile.

6. The method of claim 2 further comprising, notifying the secondary users of their access to one or more of feeds or content of feeds of a profile.

7. The method of claim 6, wherein the feeds comprise one or more of an Atom and RSS feeds.

8. A system comprising:
A unit to generate one or more profiles, each profile to receive one or more feeds over a network, the feeds for each profile selected based on one or more of pre-identification of a selected feed and pre-identified content;
A unit to provide, For each profile, one or more selected users with access to the feeds of the respective profiles.

9. The system of claim 8, wherein the unit to generate is to be utilized, at least in part, by a primary user, and the selected users are secondary users.

10. The system of claim 8, wherein the unit to generate the one or more profiles is to generate a new profile.

11. The system of claim 8, wherein the unit to generate the one or more profiles is to copy a prior profile.

12. The system of claim 11, wherein the unit to generate is to copying a prior profile and to add or remove selected feeds of the prior profile.

13. The system of claim 9 further comprising, a unit to notify the secondary users of their access to one or more of feeds or content of feeds of a profile.

14. The system of claim 13, wherein the feeds comprise one or more of an Atom and RSS feeds.

15. A machine-readable medium having stored thereon a set of instructions which when executed perform a method comprising:
Generating one or more profiles, each profile to receive one or more feeds over a network, the feeds for each profile selected based on one or more of pre-identification of a selected feed and pre-identified content;
For each profile, providing one or more selected users with access to the feeds of the respective profiles.

16. The machine-readable medium of claim 15, wherein the generating is performed, at least in part, by a primary user, and the selected users are secondary users.

17. The machine-readable medium of claim 15, wherein the generating the one or more profiles includes generating a new profile.

18. The machine-readable medium of claim 15, wherein the generating the one or more profiles includes copying a prior profile.

19. The machine-readable medium of claim 18, wherein copying another profile further includes one of adding or removing selected feeds of the prior profile.

20. The machine-readable medium of claim 16 further comprising, notifying the secondary users of their access to one or more of feeds or content of feeds of a profile.
